(19) United States
(12) Patent Application Publication
(10) Pub. No.: US 2011/0176626 A1
(43) Pub. Date: Jul. 21, 2011

(54) Pilot Signal Determination Method and Wireless Communication System Using the Same

(76) Inventors: Yen-Chin Liao, Taipei City (TW); Cheng-Hsuan Wu, Taipei City (TW); Yung-Szu Tu, Taipei County (TW)

(21) Appl. No.: 12/967,014

(22) Filed: Dec. 13, 2010

Related U.S. Application Data
(60) Provisional application No. 61/296,179, filed on Jan. 19, 2010.

(51) Int. Cl. H04L 27/28

(52) U.S. Cl. 375/260

(57) ABSTRACT

The present invention disclose a pilot signal determination method for a wireless communication system. The wireless communication system utilizes a plurality of sub-carriers. The pilot signal determination method includes steps of generating at least one vector corresponding to at least one sub-channel; and determining a plurality of pilot signals according to the at least one vector.

### CROSS REFERENCE TO RELATED APPLICATIONS

This application claims the benefit of U.S. Provisional Application No. 61/296,179, filed on Jan. 19, 2010 and entitled “METHOD FOR DETERMINING PILOT SIGNALS IN A WIRELESS SYSTEM”, the contents of which are incorporated herein by reference.

### BACKGROUND OF THE INVENTION

1. Field of the Invention

The present invention relates to a pilot signal determination method and a wireless communication system using the same, and more particularly, to a pilot signal determination method for determining an amount, pilot locations and pilot values of pilot signals in a wireless communication system.

2. Description of the Prior Art

Orthogonal frequency division multiplexing (OFDM) modulation technology is one of multi carrier modulation (MCM) transmission methods, with a basic concept of dividing a data stream of high transmission rate into several parallel sub-streams of low transmission rates, and modulating each sub-stream to different sub-carriers. In such a situation, a symbol time becomes so long that a delay induced by a channel affects a small part of the symbol time. Thus, inter symbol interference can be eliminated or reduced, and spectrum efficiency can be effectively enhanced, so as to increase data throughput. As a result, OFDM modulation technology has been widely used in many wireless communication systems, such as wireless local area network (WLAN), and the related WLAN communication protocols such as IEEE 802.11a, IEEE 802.11b, IEEE 802.11g and IEEE 802.11n all adopt OFDM modulation technology. Different to IEEE 802.11 a/g standards, IEEE 802.11n standard further utilizes multiple input multiple output (MIMO) technology, which can support multiple space time streams, and other new approaches to substantially enhance data rate and throughput, and meanwhile, increases channel bandwidth from 20 MHz to 40 MHz.

In order for a receiver to perform channel estimation for obtaining channel responses, pilot signals are usually used in communication systems as reference signals to correct frequency and timing errors. More specifically, some sub-carriers are dedicated for transmitting only pilot signals, i.e. pilot tones, which can be identified by the receiver. Therefore, the receiver can perform channel estimation to the sub-carriers and thus obtain the corresponding channel responses, so as to determine channel responses of the other sub-carriers through interpolation.

In a 20 MHz OFDM system, 64 sub-carriers are used and the sub-carriers are indexed with −32, −31, . . . , 31. Among these sub-carriers, 4 sub-carriers indexed with −21, −7, 7 and 21 are dedicated to pilot signals, i.e. pilot tones. As shown in FIG. 1, which is a schematic diagram of pilot locations in a 20 MHz OFDM system, there are 4 pilot signals, and pilot locations of the pilot signals are −21, −7, 7 and 21.

For wireless systems conforming to IEEE 802.11a/g standard, i.e. one-stream transmission, pilot values of the pilot signals of each OFDM symbol, which are denoted by p(k) and k=−7, −21, 7 and 21, are as follows:

p(−21)=1, p(−7)=1, p(7)=1, p(21)=−1.

For systems conforming to IEEE 802.11n standard, N_{STS} space-time streams are supported, wherein 1≦NSTS≦4. A pilot value of a pilot signal on a k-th sub-carrier of an n-th OFDM symbol for an i_{STS}-th space-time stream can be expressed as follows:

k=−21: p(N_{STS}, i_{STS}, n)=Ψ(N_{STS}, i_{STS}, n⊕4)

k=−7: p(N_{STS}, i_{STS}, n)=Ψ(N_{STS}, i_{STS}, (n+1⊕4)

k=7: p(N_{STS}, i_{STS}, n)=Ψ(N_{STS}, i_{STS}, (n+2)⊕4)

k=21: p(N_{STS}, i_{STS}, n)=Ψ(N_{STS}, i_{STS}, (i n+3)⊕4)

where ⊕ is modulo operation and Ψ is defined by FIG. 2, which is a schematic diagram of a pilot value table 20 in the 20 MHz OFDM system conforming to IEEE 802.11n standard.

Take pilot values of pilot signals for a 3rd OFDM symbol for a 3rd space-time stream of 4 space-time streams as example, the pilot values can be derived by referring to a row R9 of the pilot value table 20. More specifically, the pilot values of the pilot signals on −21st, −7th, 7th, and 21st sub-carriers of the 3rd OFDM symbol for an 3rd space-time stream of 4 space-time streams are Ψ(4, 3, 3 ⊕4), Ψ(4, 3, 4⊕4), Ψ(4, 3, 5⊕4), Ψ(4, 3, 6⊕4), i.e. 1, 1, −1, 1, which can be derived by an order of starting with a 4th pilot value of the row R9 until a 3rd pilot value of the row R9 as shown in a dotted line of FIG. 2. By the same token, other pilot values can be derived.

Noticeably, in order for a receiver to perform channel estimation more accurately, sequences of pilot values on sub-carriers in different OFDM symbols for one space-time stream are preferably orthogonal to each other. Take sequences of pilot values on sub-carriers in 3rd and 4th OFDM symbols for an 3rd space-time stream of 4 space-time streams as example, (Ψ(4, 3, 3⊕4), Ψ(4, 3, 4⊕4), Ψ(4, 3, 5⊕4), Ψ(4, 3, 6⊕4))=(1, 1, −1, 1) and (Ψ(4, 3, 4⊕4), Ψ(4, 3, 5⊕4), Ψ(4, 3, 6⊕4), Ψ(4, 3, 7⊕4))=(1, −1, 1, 1) are orthogonal to each other, i.e. 1−1−1+1=0, such that the receiver can perform channel estimation with statistical diversity rather than estimating the same error in different OFDM symbols. Similarly, sequences of pilot values on different sub-carriers in OFDM symbols for one space-time stream are preferably orthogonal to each other, and sequences of pilot values on sub-carriers in OFDM symbols for different space-time streams are preferably orthogonal to each other.

In a 40 MHz OFDM system conforming to IEEE 802.11n standard, 128 sub-carriers are used and 6 sub-carriers indexed with −53, −25. −11, 11, 25, and 53 are dedicated to pilot signals, i.e. pilot tones. As shown in FIG. 3, which is a schematic diagram of pilot locations in a 40 MHz OFDM system, there are 6 pilot signals and pilot locations of the pilot signals are −53, −25. −11, 11, 25, and 53. A pilot value of a pilot signal on a k-th sub-carrier of an n-th OFDM symbol for an i_{STS}-th space-time stream of N_{STS} space-time streams can be expressed as follows:

k=−53: p(N_{STS}, i_{STS}, n)=Ψ(N_{STS}, i_{STS}, n⊕6)

k=−25: p(N_{STS}, i_{STS}, n)=Ψ(N_{STS}, i_{STS}, (n+1)⊕6)

k=−11: p(N_{STS}, i_{STS}, n)=Ψ(N_{STS}, i_{STS}, (n+2)⊕6)

k=11: p(N_{STS}, i_{STS}, n)=Ψ(N_{STS}, i_{STS}, (n+3)⊕6)

k=25: p(N_{STS}, i_{ST}, n)=Ψ(N_{STS}, i_{STS}, (n+4)⊕6)

k=53: p(N_{STS}, i_{STS}, n)=Ψ(N_{STS}, i_{STS}, (n+5)⊕6)

where ⊕ is modulo operation and Ψ is defined by FIG. 4, which is a schematic diagram of a pilot value table 40 in the 40 MHz OFDM system conforming to IEEE 802.11n standard. The pilot value table 40 is similar to the pilot value table 20, and in more detail, can be derived by referring to the above description.

To achieve WLAN transmission with much higher quality, the IEEE committee is developing next-generation WLAN systems, such as a multi-station multiple input multiple output (MU-MIMO) system conforming to IEEE 802.11ac standard, which can increase channel bandwidth from 40 MHz to 80 MHz or even 160 MHz and can support more than 4 antennas, i.e. more than 4 space time streams.

Since pilot signals are used in communication systems as reference signals to correct frequency and timing error, so as to perform channel estimation more accurately. Pilot signals need to be determined for the next-generation WLAN systems.

### SUMMARY OF THE INVENTION

It is therefore an objective of the present invention to provide a pilot signal determination method for determining an amount, pilot locations and pilot values of pilot signals in a wireless communication system.

The present invention discloses a pilot signal determination method for a wireless communication system. The wireless communication system utilizes a plurality of sub-carriers. The pilot signal determination method includes steps of generating at least one vector corresponding to at least one sub-channel; and determining a plurality of pilot signals according to the at least one vector.

The present invention further discloses a wireless communication system utilizing a plurality of sub-carriers. The wireless communication system includes a microprocessor; and a memory, for storing a program, for instructing the microprocessor to execute the pilot signal determination method of claim 1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of pilot locations in a 20 MHz OFDM system.

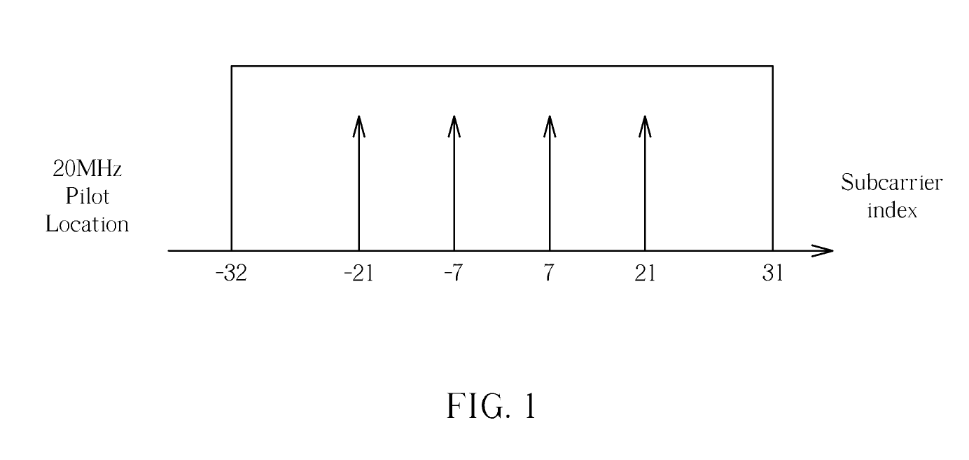

FIG. 2 is a schematic diagram of a pilot value table in a 20 MHz OFDM system conforming to IEEE 802.11n standard.

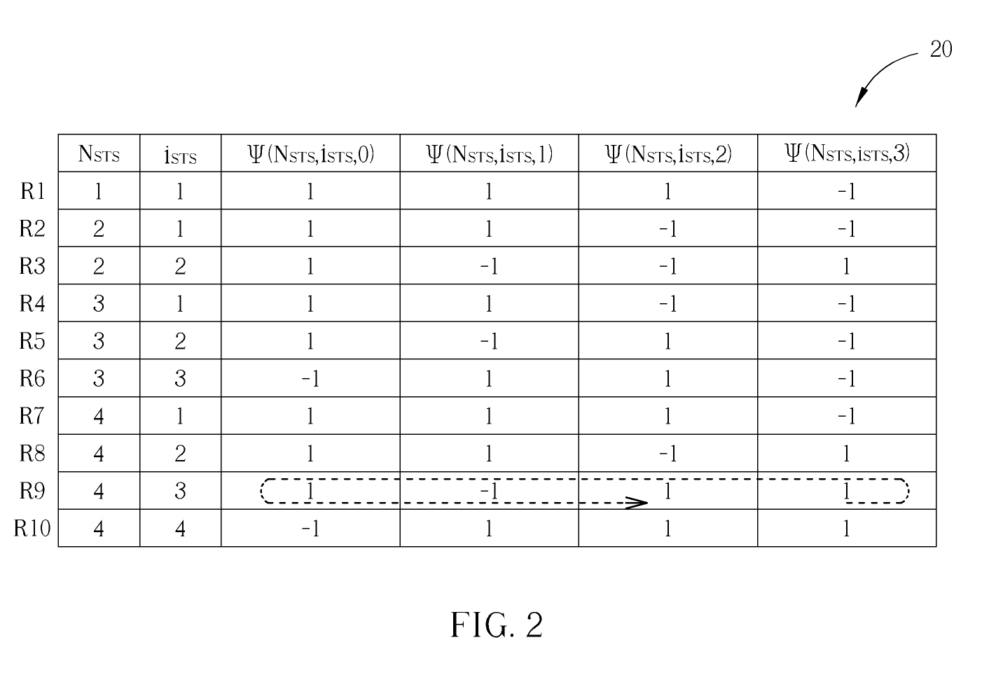

FIG. 3 is a schematic diagram of pilot locations in a 40 MHz OFDM system.

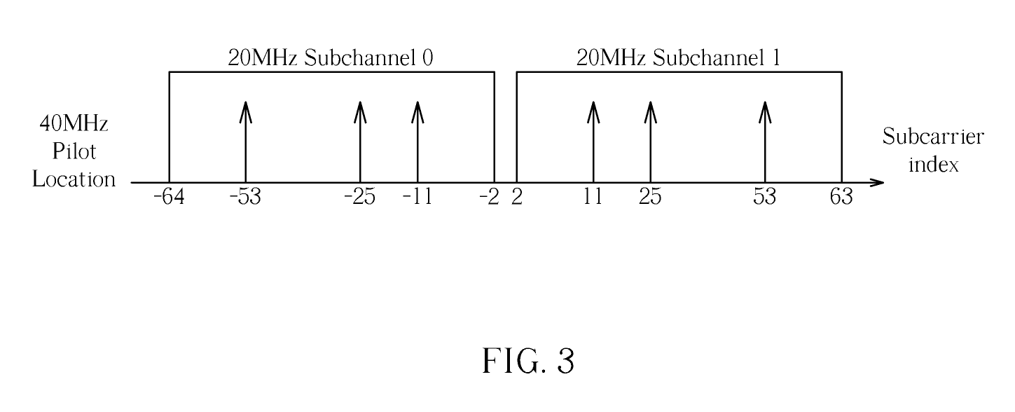

FIG. 4 is a schematic diagram of a pilot value table in the 40 MHz OFDM system conforming to IEEE 802.11n standard.

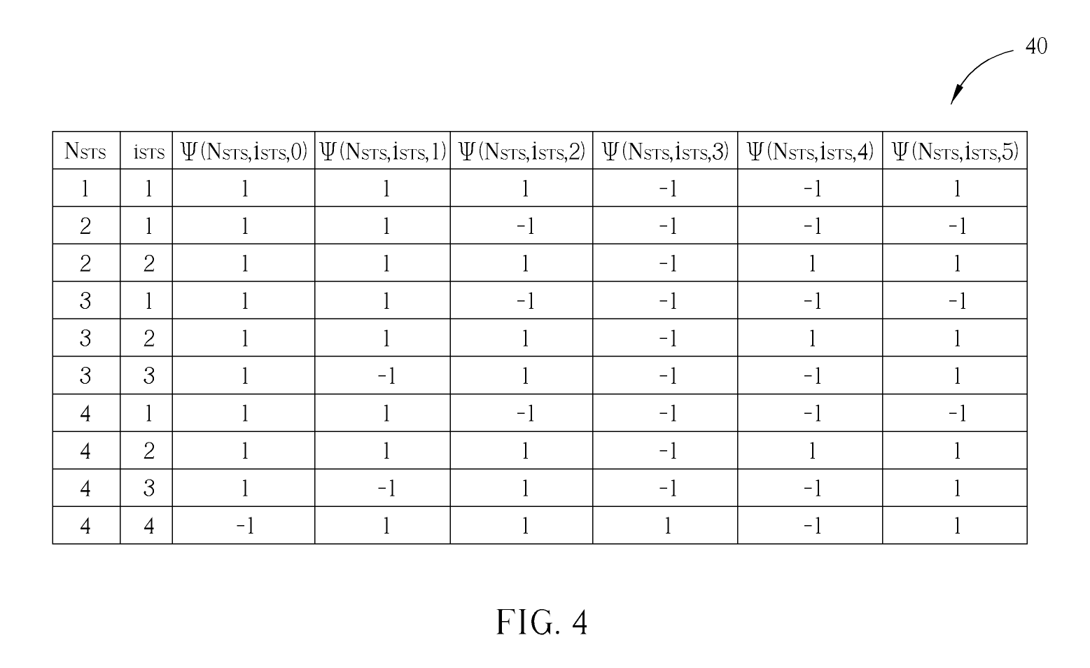

FIG. 5 is a schematic diagram of a pilot signal determination process according to an embodiment of the present invention.

FIG. 6 is a schematic diagram of a vector table of at least one vector for even OFDM symbols and odd OFDM symbols in an 80 MHz OFDM system according to an embodiment of the present invention.

FIG. 7 is a schematic diagram of a pilot value determination process according to an embodiment of the present invention.

FIG. 8 is a schematic diagram of a pilot value determination process according to another embodiment of the present invention.

FIG. 9 is a schematic diagram of a pilot value matrix for an 80 MHz OFDM system according to an embodiment of the present invention.

### DETAILED DESCRIPTION

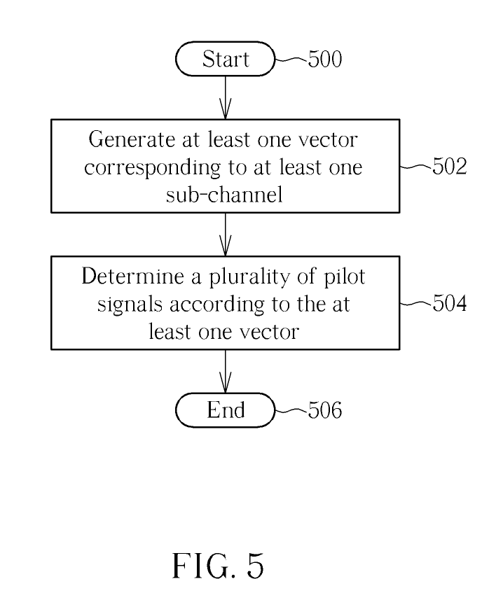

Please refer to FIG. 5, which is a schematic diagram of a pilot signal determination process 50 according to an embodiment of the present invention. The pilot signal determination process 50 is utilized for determining pilot signals in a wireless communication system utilizing a plurality of sub-carriers. The pilot signal determination process 50 includes the following steps:

Step 500: Start.

Step 502: Generate at least one vector corresponding to at least one sub-channel.

Step 504: Determine a plurality of pilot signals according to the at least one vector.

Step 506: End.

According to the pilot signal determination process 40, the present invention generates at least one vector corresponding to at least one sub-channel first, and then determines a plurality of pilot signals according to the at least one vector.

Take a wireless communication system conforming to IEEE 802.11 WLAN standard as example, the present invention generates at least one vector φ^{(s)}=[φ₀^{(s)} φ₁^{(s)} φ₂^{(s)} φ₃^{(s)}], wherein s denotes an s-th sub-channel of at least one sub-channel, and Φᵢ^{(s)}={0,1} for i=0, 1, 2, 3. Noticeably, values of the φᵢ^{(s)} and the amount of the at least one vector φ^{(s)}=[φ₀^{(s)} φ₁^{(s)} φ₂^{(s)} φ₃^{(s)}] are set according to the IEEE 802.11 WLAN standard, such as IEEE 802.11a/g, IEEE 802.11n or IEEE 802.11ac. As a result, the present invention can sum the values of the φᵢ^{(s)} as an amount L of pilot signals for one space time stream, which can be expressed as:

$$L = {\sum }_{s} {\sum }_{i} {φ}_{i}^{( s )} .$$

Moreover, the present invention can further determine a plurality of pilot locations of the pilot signals according to the at least one vector and a predefined vector. Specifically, the present invention can determine the plurality of pilot locations of the plurality of pilot signals according to a formula, which can be expressed as:

$${ϕ}^{( s )} ⊗ ( - \frac{N}{2} + s \times M + θ ) ,$$

wherein φ^{(s)} denotes the at least one vector, [symbol] denotes element-by-element multiplication, N denotes the amount of the plurality of sub-carriers, M denotes the amount of sub-carriers in one sub-channel, and θ denotes the predefined vector.

Take a wireless communication system conforming to IEEE 802.11 WLAN standard as example, the predefined vector θ is preferably [11 25 39 53]. For a 20 MHz system, which has 64 sub-carriers, 0 sub-channel, and 64 sub-carriers in one channel (N=64, S=0, M=64), the present invention generates at least one vector φ⁽⁰⁾=[1 1 1 1], and sums the values of the φᵢ^{(s)} as the amount of pilot signals for one space time stream, which can be expressed as:

1+1+1+1=4.

Then, the present invention calculates the formula to determine pilot locations of 4 pilot signals, which can be expressed as:

[1 1 1 1] [symbol] (−32+0×64+[11 25 39 53])=[−21 −7 7 21].

As a result, the present invention determines the pilot locations of the pilot signals for a 20 MHz system are −21, −7, 7 and 21, which are the same with those in the prior art.

For a 40 MHz system, which has 128 sub-carriers, 2 sub-channel, and 64 sub-carriers in one sub-channel (N=128, S=0, 1, M=64), the present invention generates at least one vector φ⁽⁰⁾=[1 0 1 1], φ⁽¹⁾[1 1 0 1], and then sums the values of the φᵢ^{(s)} as the amount of pilot signals for one space time stream, which can be expressed as:

(1+0+1+1)+(1+1+0+1)=6.

Then, the present invention calculates the formula to obtain non-zero elements as pilot locations of sub-channel 0, which can be expressed as:

[1 0 1 1] [symbol] (−64+0×64+[11 25 39 53])=[−53 0 −25 −11];

and the present invention calculates the formula to obtain non-zero elements as pilot locations of sub-channel 1, which can be expressed as:

[1 1 0 1] [symbol] (−64+1×64+[11 25 39 53])=[11 25 0 53].

As a result, the present invention determines the pilot locations of the pilot signals for a 40 MHz system are −53, −25. −11, 11, 25, and 53, which are the same with those in the prior art. As can be seen from the above, since the pilot locations of the pilot signals for the 20 MHz or 40 MHz system determined by the present invention are the same with those in the prior art. The present invention is backward-compatible with the IEEE 802.11a/g/n standards.

Furthermore, for an 80 MHz system, which has 256 sub-carriers, 4 sub-channel, and 64 sub-carriers in one sub-channel (N=128, S=0, 1, 2, 3, M=64), the present invention generates at least one vector) φ⁽⁰⁾=[0 1 0 1], φ⁽¹⁾=[0 1 0 1], φ⁽²⁾=[1 0 1 0], φ⁽³⁾=[1 0 1 0], and sums the values of the φᵢ^{(s)} as the amount of pilot signals for one space time stream, which can be expressed as:

(0+1+0+1)+(0+1+0+1)+(1+0+1+0)+(1+0+1+0)=8.

Then, the present invention calculates the formula to obtain non-zero elements as pilot locations of sub-channel 0, which can be expressed as:

[0 1 0 1] [symbol] (−128+0×64+[11 25 39 53])=[0 −103 0 −75];

and the present invention calculates the formula to obtain non-zero elements as pilot locations of sub-channel 1, which can be expressed as:

[0 1 0 1] [symbol] (−128+1×64+[11 25 39 53])=[0 −39 0 −11];

and calculates the formula to obtain non-zero elements as pilot locations of sub-channel 2, which can be expressed as:

[1 0 1 0] [symbol] (−128+2×64+[11 25 39 53])=[11 0 39 0];

and calculates the formula to obtain non-zero elements as pilot locations of sub-channel 3, which can be expressed as:

[1 0 1 0] [symbol] (−128+3×64+[11 25 39 53])=[75 0 103 0].

As a result, the present invention determines the pilot locations of the pilot signals for an 80 MHz system are −103, −75, −39, −11, 11, 39, 75 and 103.

Noticeably, vectors for an OFDM symbol may be different from other vectors for another OFDM symbol. In other words, different vectors can be defined for different OFDM symbols, which means that the pilot locations can be fixed or time-variant.

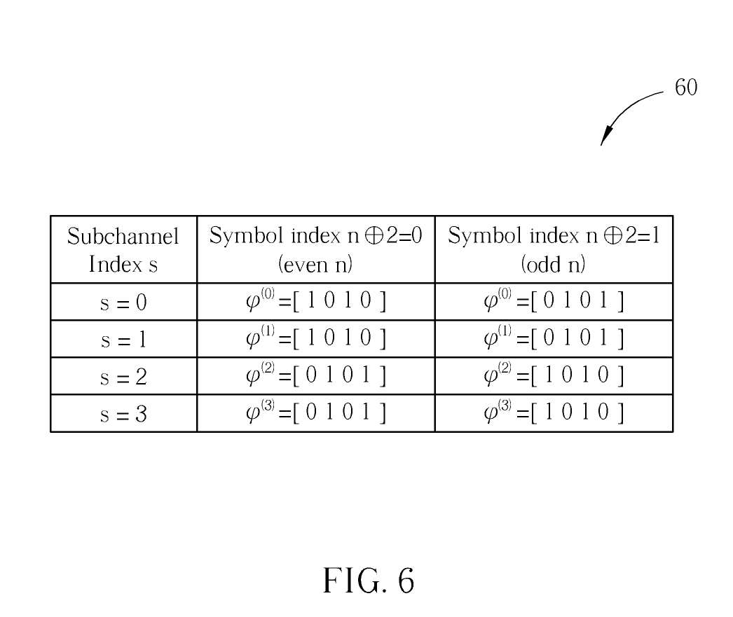

For example, please refer to FIG. 6, which is a schematic diagram of a vector table 60 of the at least one vector for even OFDM symbols and odd OFDM symbols in an 80 MHz OFDM system according to an embodiment of the present invention. As can be seen, for odd OFDM symbol indices, sub-carriers −103, −75, −39, −11, 11, 39, 75 and 103 are dedicated to pilot signals, i.e. pilot tones; similarly, for even OFDM symbol indices, sub-carriers −117, −89, −53, −25, 25, 53, 89 and 117 are dedicated to pilot signals. In other words, pilot locations are −103, −75, −39, −11, 11, 39, 75 and 103 for odd OFDM symbols, and −117, −89, −53, −25, 25, 53, 89 and 117 for even OFDM symbols. As a result, the present invention only utilizes 8 pilot signals for each OFDM symbol to perform channel estimation, but can achieve an effect of utilizing 16 pilot signals to perform channel estimation since pilot locations are different for even OFDM symbols and odd OFDM symbols.

On the other hand, in order for a receiver to perform channel estimation more accurately, sequences of pilot values on sub-carriers in different OFDM symbols for one space-time stream are preferably orthogonal to each other, sequences of pilot values on different sub-carriers in OFDM symbols for one space-time stream are preferably orthogonal to each other, and sequences of pilot values on sub-carriers in OFDM symbols for different space-time streams are preferably orthogonal to each other.

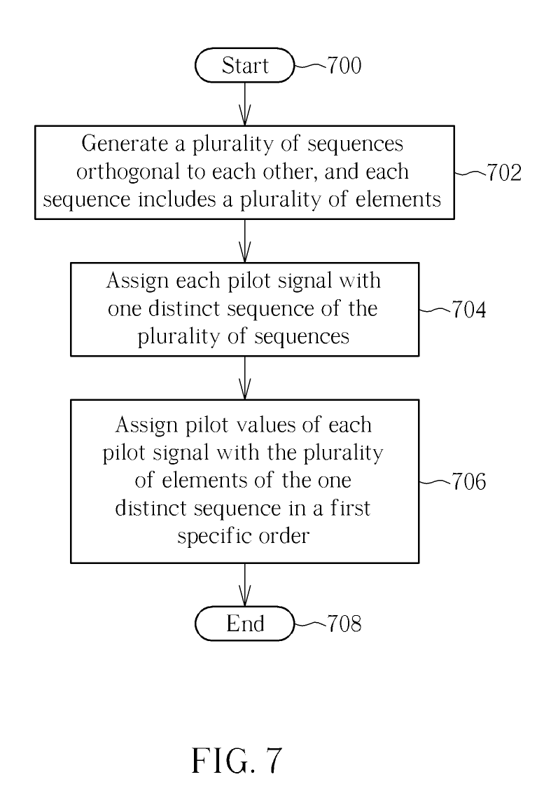

Please refer to FIG. 7, which is a schematic diagram of a pilot value determination process 70 according to an embodiment of the present invention. The pilot value determination process 70 is utilized for determining pilot values of the pilot signals in the wireless communication system. The pilot value determination process 70 includes the following steps:

Step 700: Start.

Step 702: Generate a plurality of sequences orthogonal to each other, and each sequence includes a plurality of elements.

Step 704: Assign each pilot signal with one distinct sequence of the plurality of sequences.

Step 706: Assign pilot values of each pilot signal with the plurality of elements of the one distinct sequence in a first specific order.

Step 708: End.

Since there are L pilot signals for one space time stream, according to the pilot value determination process 70, the present invention generates L×N_{STS} sequences orthogonal to each other, wherein each sequence includes U elements. Then, the present invention assigns each pilot signal of each space-time stream with one distinct sequence of the L×N_{STS} sequences. Finally, the present invention assigns pilot values of each pilot signal with the U elements of the one distinct sequence in a first specific order, e.g. the pilot value of each of the plurality of pilot signals for an n-th OFDM symbol is assigned with an (n⊕U)-th element of the one distinct sequence. As a result, sequences of pilot values on sub-carriers in OFDM symbols for different space-time streams are orthogonal to each other and sequences of the pilot values on different sub-carriers in OFDM symbols for one space-time stream are orthogonal to each other, such that channel estimation can be performed more accurately.

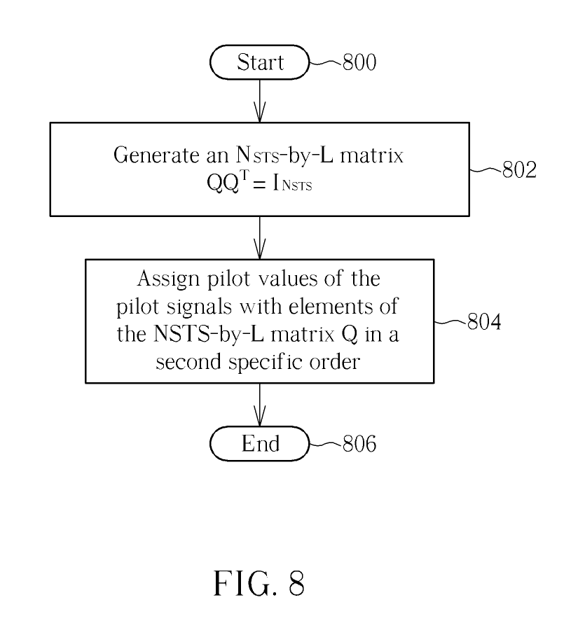

Moreover, please refer to FIG. 8, which is a schematic diagram of a pilot value determination process 80 according to an embodiment of the present invention. Difference between the pilot value determination process 80 and the pilot value determination process 70 are that the pilot value determination process 80 can reduce the amount of sequences generated in step 702, i.e. a total of L×N_{STS}×U elements. The pilot value determination process 70 includes the following steps:

Step 800: Start.

Step 802: Generate an N_{STS}-by-L matrix Q, wherein QQ^{T}=I_{N}_{_{STS}}.

Step 804: Assign pilot values of the pilot signals with elements of the N_{STS}-by-L matrix Q in a second specific order.

Step 808: End.

According to the pilot value determination process 80, the present invention generates an N_{STS}-by-L matrix Q, wherein QQ^{T}=I_{N}_{_{STS}} and thus rows of the N_{STS}-by-L matrix Q are orthogonal to each other. In other words, the pilot value determination process 80 only generates N_{STS} sequences orthogonal to each other, wherein each sequence includes L elements, i.e. a total of N_{STS}-by-L elements rather than L×N_{STS}×U elements. Then, the present invention assigns pilot values of the pilot signals with elements of the N_{STS}-by-L matrix Q in a second specific order, e.g. the pilot value of an ((1+n)⊕L)-th pilot signal on an i_{STS}-th space-time stream for an n-th OFDM symbol is assigned with an (i_{STS}, 1) element of the N_{STS}-by-L matrix. As a result, sequences of pilot values on sub-carriers in OFDM symbols for different space-time streams are orthogonal to each other and sequences of the pilot values on different sub-carriers in OFDM symbols for one space-time stream are orthogonal to each other, such that the present invention can perform channel estimation more accurately.

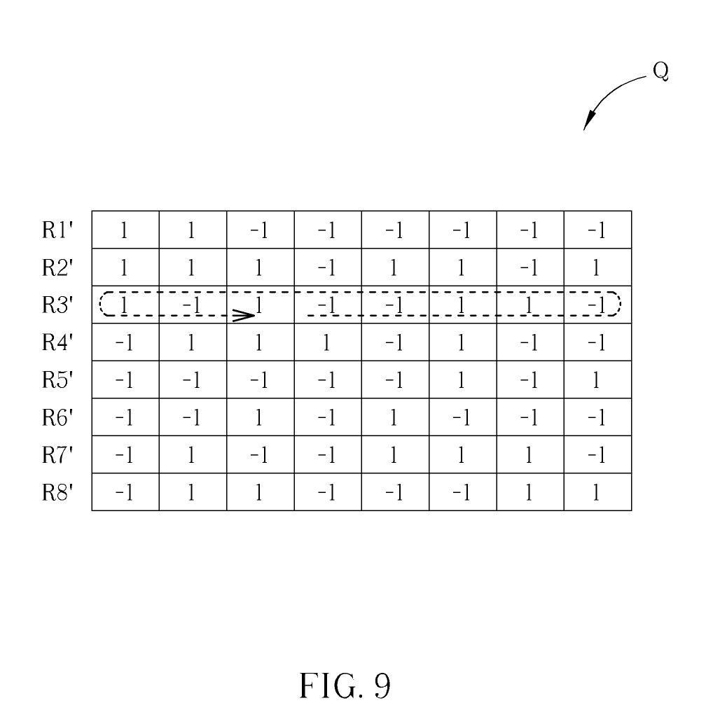

For example, please refer to FIG. 9, which is a schematic diagram of a pilot value matrix Q for an 80 MHz OFDM system according to an embodiment of the present invention. The pilot value matrix Q is an 8-by-8 matrix generated according to step 802, which means the pilot value matrix Q is used for N_{STS} 8 and 8 pilot sub-carriers, and rows of the pilot value matrix Q are orthogonal to each other. For the 80 MHz OFDM system utilizing the vector table 60, pilot values of pilot signals on a k-th sub-carrier of an n-th OFDM symbol for an i_{STS}-th space-time stream can be expressed as follows:

For even symbol index n:

$$k = - 117 : p ( {i}_{STS} , n ) = Q ( {i}_{STS} , ⌊ \frac{n}{2} ⌋ ⊕ 8 )$$

$$k = - 89 : p ( {i}_{STS} , n ) = Q ( {i}_{STS} , ( ⌊ \frac{n}{2} ⌋ + 1 ) ⊕ 8 )$$

$$k = - 53 : p ( {i}_{STS} , n ) = Q ( {i}_{STS} , ( ⌊ \frac{n}{2} ⌋ + 2 ) ⊕ 8 )$$

$$k = - 25 : p ( {i}_{STS} , n ) = Q ( {i}_{STS} , ( ⌊ \frac{n}{2} ⌋ + 3 ) ⊕ 8 )$$

$$k = 25 : p ( {i}_{STS} , n ) = Q ( {i}_{STS} , ( ⌊ \frac{n}{2} ⌋ + 4 ) ⊕ 8 )$$

$$k = 53 : p ( {i}_{STS} , n ) = Q ( {i}_{STS} , ( ⌊ \frac{n}{2} ⌋ + 5 ) ⊕ 8 )$$

$$k = 89 : p ( {i}_{STS} , n ) = Q ( {i}_{STS} , ( ⌊ \frac{n}{2} ⌋ + 6 ) ⊕ 8 )$$

$$k = 117 : p ( {i}_{STS} , n ) = Q ( {i}_{STS} , ( ⌊ \frac{n}{2} ⌋ + 7 ) ⊕ 8 )$$

For odd symbol index n:

$$k = - 103 : p ( {i}_{STS} , n ) = Q ( {i}_{STS} , ( ⌊ \frac{n}{2} ⌋ + 2 ) ⊕ 8 )$$

$$k = - 75 : p ( {i}_{STS} , n ) = Q ( {i}_{STS} , ( ⌊ \frac{n}{2} ⌋ + 3 ) ⊕ 8 )$$

$$k = - 39 : p ( {i}_{STS} , n ) = Q ( {i}_{STS} , ( ⌊ \frac{n}{2} ⌋ + 4 ) ⊕ 8 )$$

$$k = - 11 : p ( {i}_{STS} , n ) = Q ( {i}_{STS} , ( ⌊ \frac{n}{2} ⌋ + 5 ) ⊕ 8 )$$

$$k = 11 : p ( {i}_{STS} , n ) = Q ( {i}_{STS} , ( ⌊ \frac{n}{2} ⌋ + 6 ) ⊕ 8 )$$

$$k = 39 : p ( {i}_{STS} , n ) = Q ( {i}_{STS} , ( ⌊ \frac{n}{2} ⌋ + 7 ) ⊕ 8 )$$

$$k = 75 : p ( {i}_{STS} , n ) = Q ( {i}_{STS} , ⌊ \frac{n}{2} ⌋ ⊕ 8 )$$

$$k = 103 : p ( {i}_{STS} , n ) = Q ( {i}_{STS} , ( ⌊ \frac{n}{2} ⌋ + 1 ) ⊕ 8 )$$

where └ ┘ is floor or chop-off operation, e.g. └1.5┘=1, ⊕ is modulo operation and Q is defined by the pilot value matrix Q. As a result, sequences of pilot values on sub-carriers in OFDM symbols for different space-time streams are orthogonal to each other and sequences of the pilot values on different sub-carriers in OFDM symbols for one space-time stream are orthogonal to each other, such that the present invention can perform channel estimation more accurately.

Take pilot values of pilot signals for a 3rd OFDM symbol for a 3rd space-time stream as example, the pilot values can be derived by referring to a row R3′ of the pilot value matrix Q. More specifically, since the 3rd OFDM symbol is an odd symbol, pilot locations of the pilot signals are −103, −75, −39, −11, 11, 39, 75 and 103, and pilot values of the pilot signals on −103rd, −75th, −39th, −11th, 11th, 39th, 75th and 103rd sub-carriers of the 3rd OFDM symbol for an 3rd space-time stream are Q(3, (1+2)⊕8), Q(3, (1+3)⊕8), Q(3, (1+4)⊕8), Q(3, (1+5)⊕8), Q(_{3,} (1+6)⊕8), Q(_{3,} (1+7)⊕8), Q(3, 1⊕8), Q(3 (1+1)⊕8), i.e. −1, −1, 1, 1, −1, 1, −1, 1 which can be derived by an order of starting with a 4th element of the row R3′ until a 3rd element of the row R3′ as shown in a dotted line of FIG. 9. By the same token, other pilot values can be derived.

Noticeably, the spirit of the present invention is to generate at least one vector corresponding to at least one sub-channel, so as to determine the amount, pilot locations and pilot values of pilot signals accordingly. Those skilled in the art should make modification or alteration accordingly. For example, the wireless communication system preferably conforms to IEEE 802.11 WLAN standard, and can be other wireless communication system utilizing pilot signals as well. Values of elements of the predefined vector are preferably separated by a specific value in between as the predefined vector [11 25 39 53] for the wireless communication system conforming IEEE 802.11 WLAN standard, such that pilot locations are distributed in sub-carriers more evenly for performing channel estimation more accurately and reducing circuitry complexity. Pilot locations can be fixed or time-variant as shown in FIG. 6, where pilot locations for different for even OFDM symbols and odd OFDM symbols, but other time-variant scheme can be applied as well, which is not limited to this.

On the other hand, as to hardware realization, the pilot signal determination process 50 and the pilot value determination processes 70, 80 can be transformed to programs with a format of software or firmware, and stored in a memory of a wireless communication device, for instructing a microprocessor to execute the steps of the pilot signal determination process 50 and the pilot value determination processes 70, 80. Transforming the pilot signal determination process 50 and the pilot value determination processes 70, 80 into an adequate program to realize a corresponding setting device should be an ordinary skill in the art.

As mentioned in the above, the prior art does not provide a method for determining pilot signals for next-generation WLAN systems, such as wireless communication systems conforming to IEEE 802.11ac standard, which can increase channel bandwidth from 40 MHz to 80 MHz or even 160 MHz and support more than 4 antennas, i.e. more than 4 space time streams. In comparison, the present invention can determine the amount, pilot locations and pilot values of pilot signals for the next-generation WLAN systems, and can be backward-compatible with the IEEE 802.11a/g/n standards. Moreover, pilot locations for odd OFDM symbols can be different from those for even OFDM symbols, such that the present invention can utilize less pilot signals for each OFDM symbol to achieve an effect of utilizing more pilot signals to perform channel estimation.

To sum up, the present invention can determine the amount, pilot locations and pilot values of pilot signals for the next-generation WLAN systems, and can utilize different pilot locations for odd OFDM symbols and for even OFDM symbols to achieve high performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pilot signal determination method for a wireless communication system, the wireless communication system utilizing a plurality of sub-carriers, the pilot signal determination method comprising:
generating at least one vector corresponding to at least one sub-channel; and
determining a plurality of pilot signals according to the at least one vector.

2. The pilot signal determination method of claim 1, wherein the at least one vector is expressed as:
φ^{(s)}=[φ₀^{(s)} φ₁^{(s)} φ₂^{(s)} φ₃^{(s)}],
wherein s denotes an s-th sub-channel of the at least one sub-channel, and φᵢ^{(s)}={0,1} for i=0, 1, 2, 3.

3. The pilot signal determination method of claim 2, wherein generating the at least one vector corresponding to the at least one sub-channel comprises:
setting a plurality of values of the φᵢ^{(s)}.

4. The pilot signal determination method of claim 2, wherein determining the plurality of pilot signals according to the at least one vector comprises:
summing a plurality of values of the φᵢ^{(s)} as an amount of a plurality of pilot signals for one space time stream, which can be expressed as:
$$L = {\sum }_{s} {\sum }_{i} {φ}_{i}^{( s )} .$$

5. The pilot signal determination method of claim 2, wherein determining the plurality of pilot signals according to the at least one vector comprises:
determining a plurality of pilot locations of the plurality of pilot signals according the at least one vector and a predefined vector.

6. The pilot signal determination method of claim 5, wherein the predefined vector comprises a plurality of elements, and a plurality of values of the plurality of elements are separated by a specific value in between.

7. The pilot signal determination method of claim 5, wherein determining the plurality of pilot locations of the plurality of pilot signals according the at least one vector and the predefined vector comprises:
determining the plurality of pilot locations of the plurality of pilot signals according to a formula, which can be expressed as:
$${ϕ}^{( s )} ⊗ ( - \frac{N}{2} + s \times M + θ ) ,$$
wherein φ^{(s)} denotes the at least one vector, [symbol] denotes element-by-element multiplication, N denotes an amount of the plurality of sub-carriers, M denotes an amount of sub-carriers in one sub-channel, and θ denotes the predefined vector.

8. The pilot signal determination method of claim 7, wherein the predefined vector is [11 25 39 53].

9. The pilot signal determination method of claim 8, wherein the wireless communication system is a 20 MHz system and the at least one vector is φ⁽⁰⁾=[1 1 1 1].

10. The pilot signal determination method of claim 8, wherein the wireless communication system is a 40 MHz system and the at least one vector is φ⁽⁰⁾=[1 0 1 1], φ⁽¹⁾=[1 1 0 1].

11. The pilot signal determination method of claim 8, wherein the wireless communication system is an 80 MHz bandwidth system and the at least one vector is φ⁽⁰⁾=[0 1 0 1], φ⁽¹⁾=[0 1 0 1], φ⁽²⁾=[1 0 1 0], φ⁽³⁾=[1 0 1 0].

12. The pilot signal determination method of claim 11, wherein the plurality of pilot locations are −103, −75, −39, −11, 11, 39, 75 and 103.

13. The pilot signal determination method of claim 8, wherein the wireless communication system is an 80 MHz system and the at least one vector is φ⁽⁰⁾=[1 0 1 0], φ⁽¹⁾=[1 0 1 0], φ⁽²⁾=[0 1 0 1], φ⁽³⁾=[0 1 0 1].

14. The pilot signal determination method of claim 13, wherein the plurality of pilot locations are −117, −89, −53, −25, 25, 53, 89 and 117.

15. The pilot signal determination method of claim 1, wherein the at least one vector for an Orthogonal frequency-division multiplexing (OFDM) symbol is different from other at least one vector for another OFDM symbol.

16. The pilot signal determination method of claim 1, wherein the at least one vector is for even OFDM symbols, and are different from other at least one vector for odd OFDM symbols.

17. The pilot signal determination method of claim 1, wherein determining the plurality of pilot signals according to the at least one vector comprises:
determining a plurality of pilot values of the plurality of pilot signals.

18. The pilot signal determination method of claim 17, wherein determining the plurality of pilot values of the plurality of pilot signals comprises:
generating a plurality of sequences orthogonal to each other, each comprising a plurality of elements;
assigning each of the plurality of pilot signals with one distinct sequence of the plurality of sequences; and
assigning the pilot values of each of the plurality of pilot signals with the plurality of elements of the one distinct sequence in a first specific order.

19. The pilot signal determination method of claim 17, wherein the first specific order is that the pilot value of each of the plurality of pilot signals for an n-th OFDM symbol is assigned with an (n⊕U)-th element of the one distinct sequence.

20. The pilot signal determination method of claim 17, wherein determining the plurality of pilot values of the plurality of pilot signals comprises:
generating an N_{STS}-by-L matrix; and
assigning the pilot values of the plurality of pilot signals with a plurality of elements of the N_{STS}-by-L matrix in a second specific order.
wherein N_{STS} denotes an amount of a plurality of space time streams, L denotes an amount of a plurality of pilot signals for one space time stream, and QQ^{T}=I_{N}_{_{STS}}, where Q denotes the N_{STS}-by-L matrix.

21. The pilot signal determination method of claim 17, wherein the second specific order is that the pilot value of an ((1+n)⊕L)-th pilot signal on an i_{STS}-th space-time stream for an n-th OFDM symbol is assigned with an (i_{STS}, 1) element of the N_{STS}-by-L matrix.

22. A wireless communication system utilizing a plurality of sub-carriers, comprising:
a microprocessor; and
a memory, for storing a program, for instructing the microprocessor to execute the pilot signal determination method of claim 1.
